(19) United States
(12) Patent Application Publication
(10) Pub. No.: US 2023/0252838 A1
(43) Pub. Date: Aug. 10, 2023

(54) AUTOMATIC SYSTEM FOR DISPENSING CUSTOMER-SPECIFIC PERSONAL CARE ARTICLES AND PRODUCTS

(71) Applicant: Life Spectacular, Inc., D/B/A Proven Skincare, San Francisco, CA (US)

(72) Inventors: Zaoshi Amy Yuan, San Francisco, CA (US); Ming S. Zhao, San Francisco, CA (US); Luke Weston, New York, NY (US)

(21) Appl. No.: 18/106,390

(22) Filed: Feb. 6, 2023

Related U.S. Application Data
(60) Provisional application No. 63/307,527, filed on Feb. 7, 2022.

(51) Int. Cl. G07F 9/00; G07F 13/06

(52) U.S. Cl. CPC G07F 9/006; G07F 9/009; G07F 13/06

(57) ABSTRACT

Systems and methods for operating a vending machine and one or more remote servers or services to generate user-specific recommendations of products or services by collaborative filtering executed and/or performed by one or more trained or untrained predictive models configured to ingest product attribute(s), product purpose(s), user location data, and/or user demographics. The predictive model(s) are leveraged to detect and determine user-specific preferences for, and preferences against, particular attributes, features, ingredients, aesthetic styles, and so on. Recommendations are leveraged to provide a custom selection of products and/or a custom mixture of products from the vending machine.

### CROSS-REFERENCE TO RELATED APPLICATION

This application is a nonprovisional patent application of and claims the benefit under 35 U.S.C. § 119(e) of U.S. Provisional Patent Application No. 63/307,527, filed Feb. 7, 2022, and titled “Automatic System For Dispensing Customer-Specific Personal Care Articles and Products”, the contents of which are incorporated herein by reference in its entirety.

### TECHNICAL FIELD

Embodiments described herein relate to automatic control of an article dispensing device and, in particular, to article dispensing and mixing devices configured to dispense customized, operator-specific products.

### BACKGROUND

A vending machine can include a cabinet that houses one or more discrete compartments, such as a first compartment to store inventory and a second compartment to enclose control electronics such as a display, a selection system, a transaction system, and so on. Some vending machines include a recommendation system to assist with product selection decisions.

Conventional recommendation systems present a list of available products sorted by customer reviews and/or historical product purchase volume. This technique encourages an undesirable feedback effect in which a product within the vending machine that is recommended is more likely to be purchased, and a product within the vending machine that is purchased is more likely to be recommended. Especially in inventory-constrained environments, like vending machines, this feedback effect converges recommendations quickly to a limited set of products, interfering with efficient inventory management.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 is a schematic representation of a client-server architecture of a system, such as described herein.

FIG. 2 is a schematic representation of a host server of the client-server architecture of the system of FIG. 1.

FIG. 3 is a schematic representation of a vending machine, such as described herein.

FIG. 4 is a schematic representation of another vending machine, such as described herein.

FIG. 5 is a schematic representation of yet another vending machine, such as described herein.

FIG. 6 depicts a vending machine, such as described herein, communicating with a client device such as a cellular phone.

FIG. 7 depicts another vending machine, such as described herein, communicating with a client device such as a cellular phone.

FIG. 8A is a signal/process flow diagram depicting a client device in communication with the host server of FIG. 2 and rendering a sample graphical user interface configured to solicit input from a user of the client device so that the host server can provide a recommendation to that user.

FIG. 8B is a signal/process flow diagram depicting data source(s) accessible to the backend service of FIG. 8A that can supply information or data to a predictive model to ingest to provide a recommendation to the user.

FIG. 8C is a signal/process flow diagram depicting the client device of FIG. 8A rendering a graphical user interface presenting one or more product recommendations to the user of the client device.

FIG. 9 is a flowchart corresponding to a method of operating a vending machine as described herein.

FIG. 10 is a flowchart corresponding to another method of operating a vending machine as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to automated vending machines that include a recommendation system configured to provide personalized product recommendations—and in particular, recommendations for personal care products, such as skincare products, haircare products, hygiene products, and the like—to operators of the machine, also referred to as customers.

In particular, embodiments described herein relate to automated vending machines configured to communicably couple to customer devices (e.g., cellular phones, wearable devices) and/or one or more remote servers or services to obtain customer-specific information such as demographic information, allergy information, medical information, prescription information, and the like. Once the vending machine has obtained customer-specific information (from one or more sources), the vending machine can be configured to determine a set of ingredients and/or proportions thereof to recommend to the customer.

The ingredient set and proportions thereof can be recommended to the customer by leveraging a recommendation system as described herein which can include, and/or may be operated with, a predictive model (e.g., AI/ML) configured to receive customer information as input and to provide one or more active and/or inactive ingredients appropriate for that customer.

The recommendations generated from customer information can be used, in some embodiments, to mix a custom personal care product for the customer within the vending machine itself. In such constructions, the vending machine can include a mixing system configured to operate with a selection and conveying system to obtain suitable/recommended quantities of active ingredients, inactive ingredients (e.g., bases, moisturizers, water content, and so on), aesthetic ingredients (e.g., fragrances, colorants, and so on), and packages (e.g., bottles, jars, boxes, and the like).

In some embodiments, recommendations generated from customer information can be used to select custom pre-mixed personal care products for the customer. For example, a vending machine as described herein may maintain an inventory of N premixed sunscreen formulations, each having different proportions of certain active ingredients or inactive ingredients. Some of the N formulations may have particular colorants or fragrances, some may be fragrance free. In these embodiments, the recommendations for particular ingredients (both ingredients to include and ingredients to exclude, such as may be the case if the customer information indicates an allergy or strong preference against colorants, fragrance, and so on) and proportions thereof can be used to select a pre-mixed product from the inventory of the vending machine.

In yet other examples, recommendations generated from customer information as described herein can be used to select multiple pre-mixed personal care products each having different ingredient sets. These pre-mixed personal care products can be provided to the customer along with instructions for the customer to mix the products together. In this way, a greater quantity of customization can be achieved without increasing inventory of the vending machine. For example, a set of pre-mixed personal care products stored by the vending machine may have different quantities of Ingredient A.

A first product may include Ingredient A at 5% by weight, and a second product may include Ingredient A at 12% by weight. Recommendations generated from customer information for a particular customer may indicate an optimal proportion of Ingredient A is 8-9% by weight. In this circumstance, the vending machine may provide to the customer both the first product and the second product, instructing the customer to mix both products together prior to use—which as known to a person of skill in the art will result in an ingredient concentration of 8.5% of Ingredient A.

It may be appreciated that the foregoing example is merely one example; other examples can consider different proportions of different ingredients in single pre-mixed products. Selections from these products may be made by an order of priority for each individual ingredient. For example, the recommendation system may determine that a precise volume of Ingredient A is a higher priority (e.g., more important, more therapeutic) than a precise volume of Ingredient B. For example, a first product may include 5% Ingredient A, and 10% Ingredient B and a second product may include 10% Ingredient A and 0% Ingredient B. Recommendations generated from customer information for a particular customer may indicate an optimal proportion of Ingredient A is 8-9%, and 10% of Ingredient B. In this circumstance, the vending machine may provide to the customer both the first product and the second product, instructing the customer to mix both products together prior to use, resulting in a combined product with 7.5% of Ingredient A and 5% of Ingredient B.

In still other embodiments, a vending machine as described herein can be configured to provide customer-specific pre-mixed personal care products and one or more additives to be added by the customer. For example, the previous example customer may also be provided with an additive (supplement) of Ingredient B to increase the concentration specifically of Ingredient B to the targeted 10%.

In these and related embodiments, a vending machine as described herein can be configured to generate recommendations and/or modify recommendations based on an environment in which the vending machine is placed. For example, if the vending machine is placed in a travel center, such as an airport, a recommendation may be made based on a traveler's destination rather than the traveler's current location. In another example, if the vending machine is placed in a retail location, the vending machine may be configured to make recommendations in consideration of inventory of the vending machine and the retail location itself. For example, the vending machine may be configured to provide a first product to a customer from the vending machine, and may be configured to recommend another product not within the vending machine, but within the retail location.

In some embodiments, the vending machine can be further configured to provide customer-specific packaging and/or labeling. For example, the customer's name may be printed on a container prior to dispensing the product to the customer. In other cases, recommended routine information literature can be printed within the vending machine and can be dispensed with the customized product.

In yet other examples, product volume can be customer specific. For example, a vending machine as described herein can be configured to provide sample sizes, travel sizes, traditional retail sizes, and so on. In some configurations, sizing may be based on customer information such as a travel destination or a travel duration. For example, if a vending machine as described herein is located in a travel center, a customer's travel destination can inform a recommendation for one or more personal care products and a customer's travel duration can inform product sizing.

In yet other examples, a vending machine as described herein can be configured to provide multiple different types of personal care products to a customer, each or some of which may be customized for that customer. For example, in one embodiment, a vending machine placed at an airport may be configured to scan boarding passes. In response to scanning a boarding pass, the vending machine can identify the named passenger and with this name access an account associated with the traveler/customer. Once the traveler/customer is identified, customer information can be obtained from the customer's cellular phone or other device and/or from one or more remote servers or services.

Once customer information is obtained, the vending machine can be configured to provide to the customer: a travel-sized custom toothpaste mixed to the preferences of the customer and sized appropriately based on the travel duration of the customer; a travel-sized custom shampoo and conditioner each mixed to the preferences of the customer, modified based on the travel destination (e.g., based on humidity, UV index, predicted weather, and so on) and sized appropriately based on the travel duration of the customer; a travel-sized deodorant that matches the traveler's brand preference (from customer information); a travel-sized sunscreen mixed to the preferences and skincare needs of the customer and sized appropriately based on the travel duration and travel destination of the customer; a travel-sized night custom cream sized appropriately based on the travel duration of the customer; and so on. Each of these custom products can have a custom-printed label and/or custom printed literature describing a recommended routine for use of the products. In these embodiments, the traveler may not be required to pack any personal care products for a particular trip.

It may be appreciated that these foregoing example embodiments are not exhaustive of the various ways in which a vending machine—and in particular a vending machine incorporating a recommendation system as described herein—can be configured or operated.

More generally, a vending machine as described herein includes a cabinet that encloses, in many examples, a first compartment and a second compartment. The first compartment can be a temperature, humidity, and/or pressure controlled compartment configured to store inventory for the vending machine.

The second compartment can include and/or enclose one or more systems of the vending machine, such as but not limited to or expressly requiring a conveying system, an article selection system, a mixing system, a packaging system, a labeling system, a selection input system (also referred to as an operator input system), a recommendation system, a transaction processing system, and one or more controllers.

The controllers may include control electronics intercoupled with one or more other systems to coordinate interoperation between those systems. In many examples, control electronics may be shared across multiple systems; in some configurations control electronics include one or more processors, one or more memory or data storage devices, one or more displays, and/or one or more communication interfaces. In these examples, one or more foregoing described systems can be implemented as instances of software instantiated by cooperation of a processor and a memory. The processor may cause the memory to access at least one executable asset (e.g., computer code, executable code, binary executable files, and so on) from a memory and in response, instantiate an instance of software configured to perform, coordinate, or otherwise supervise a method, function, or system of the vending machine such as described herein.

For example, an operator of the vending machine can leverage a selection system to provide input to a recommendation system, which in turn may provide one or more product recommendations and/or product combination recommendations to an article/inventory selection system. The operator can thereafter leverage the selection system and/or the transaction system to purchase one or more of the recommended products. Upon completion of a successful transaction, the article selection system can retrieve, from the first compartment, the product(s) recommended by the recommendation system.

The conveying system can transport the selected product(s) to the packaging system and/or the labeling system which can be operated to package the selected product(s) and/or print one or more custom labels and/or literature identifying the product(s), the operator, the vending machine, a recommended use or regimen for the product(s), or any combination thereof. Thereafter, the conveying system can be configured to transport the packaged and labeled product(s) to a retrieval compartment for the operator to retrieve, thereby completing a transaction.

Many embodiments described herein relate in particular to a recommendation system of a vending machine, such as described herein. As noted with respect to many embodiments described herein, the recommendation system can be configured to make personalized product recommendations based on user inputs, outputs from machine learning/predictive models, and/or current inventory of a vending machine incorporating the product recommendation system.

In many embodiments, a recommendation system as described herein is configured, at least in part, as an instance of software instantiated over a processor allocation and a memory allocation of one or more control electronics within a vending machine cabinet.

The recommendation system can be configured to interface with one or more network interface cards and/or other communication interfaces to communicably couple to one or more external services and/or user devices, such as cellular phones or wearable electronic devices. The recommendation system can leverage these connection interfaces to retrieve information from, and provide information to, customer devices and/or remote servers or services (e.g., which may store previously-collected customer information or data). More broadly, the recommendation system can leverage customer devices and/or remote services to aggregate information about the customer (herein “customer information”) in order to make one or more recommendations specific to that customer.

For example, in one embodiment, the recommendation system of a vending machine as described herein can be configured to communicate with a customer's cellular phone, which may be in proximity of the vending machine. Communication can take place via code exchange (e.g., two-way or one-way code scanning or entry, such as bar code scanning, QR code scanning, and so on), or via a wireless communication protocol such as Bluetooth or Wi-Fi. The vending machine can couple to the customer's device and can obtain customer information therefrom. More particularly, in some cases, the vending machine can be configured to interface with an instance of software executing on the customer's device; the instance of software can be configured to store customer information and to provide that information—with consent of the customer—to a vending machine that requests such information.

In some cases, communication can take place over the open Internet, facilitated by a remote server or service. In this example, as with others, the recommendation system can communicably couple to a software application instantiated on the customer's device to retrieve customer information which can include one or more preferences of the customer, previously provided as input to the software application.

As one example, a customer may have previously provided input to the software application (executing on the customer's client device) that the customer has an allergy to a particular fragrance additive often found in personal care products. In this example, the recommendation system can receive from the software instance on the customer's device, information identifying this allergy. In response to receiving this information, the recommendation system of the vending machine can filter out (e.g., not recommend or select) all products within the vending machine that include the additive to which the customer is allergic.

In other embodiments, the recommendation system of a vending machine as described herein can be configured to communicate with a remote server or service. Communication can take place via a wireless or wired communication protocol such as Bluetooth, Ethernet, cellular networks, or Wi-Fi. In some cases, communication can take place at least partially over the open Internet, optionally facilitated by a remote server or service (e.g., a proxy service, authentication service, gateway service, and so on).

In this example, the recommendation system can receive information from the remote server or service that the customer has an allergy to the particular fragrance additive often found in personal care products. In this example, as with the previous example, the recommendation system can filter out all products within the vending machine (or otherwise within the scope of products and/or ingredients that can be recommended by the recommendation system) that include the additive to which the customer is allergic.

In many embodiments, as noted above, a recommendation system as described herein can provide finely-tailored product recommendations to a customer. For example, as noted above in some cases, a vending machine can include a mixing system configured to blend a customer-specific product from ingredients stored within the vending machine.

The ingredients selected for a customer-specific blend can be selected and/or recommended by the recommendation system. In other cases, a specific set of products—in some cases, to be mixed (and/or used) by the customer according to customer preferences and/or instructions provided to the customer—can be selected by the recommendation system.

In these and related embodiments, the recommendation system can be configured to leverage one or more predictive models configured to receive, as input, information from and/or about the customer (from either direct customer input, via communication with the customer's nearby electronic device, and/or via querying a remote database) and to provide as output a set of ingredients and proportions of those ingredients (and/or use/consumption schedules for those ingredients) most likely to appeal to the customer.

In some cases, the predictive model may be configured to predict a likelihood of receiving a positive review from a customer; ingredients and/or products provided as output from the predictive model may be those ingredients (and proportions) most likely to appeal to the customer (thereby increasing a likelihood that the customer will leave a positive review).

In still further embodiments, a vending machine including a recommendation system as described herein can be configured to modify outputs from a predictive model based, at least in part, on supplemental information stored in the vending machine and/or provided to the vending machine by a customer.

For example, as noted above, a vending machine as described herein may be placed in an airport or other travel center. In some configurations, the vending machine may be configured to scan a boarding pass or ticket in order to query a traveler database to obtain information about the traveler customer. The vending machine and/or the recommendation system can leverage traveler information to modify recommendations.

For example, in one embodiment, a vending machine as described herein may be configured to provide skincare product recommendations and/or custom mixtures. In these embodiments, a customer/user of the vending machine may complete a questionnaire that collects particular demographic and medical information (e.g., age, sex, skin type, skin concerns, dermatological conditions, allergies, and so on).

With the questionnaire results, the recommendation system may be able to provide a custom sunscreen recommendation and/or custom sunscreen mixture that contains active ingredients most likely to provoke a positive review from the customer/user. In this example, however, the vending machine may also leverage information obtained by scanning the user's boarding pass to determine that the user is traveling, for a brief period of time, to an area with a high UV index and predicted sunny weather with high humidity.

In response, the recommendation system may adjust the sunscreen mixture output from the predictive model to increase a sun protection factor and, additionally, change a base for the custom sunscreen to a base with less moisturizer. Further still, the vending machine may leverage travel duration to set a particular product size or volume; the shorter the traveler's trip, the smaller the recommended purchase size may be.

The foregoing example embodiments described in reference to a recommendation system of a vending machine are not exhaustive of all implementations. In particular, more generally, embodiments described herein reference systems and methods for generating user-specific personal care products and recommendations by leveraging outputs of one or more predictive models configured to ingest attributes of existing personal care products (e.g., ingredients, ingredient proportions, and so on), customer reviews, medical and/or dermatological data, user location data, self-reported user skin concern information, and/or user demographics.

An example embodiment described herein includes a vending machine communicably coupled to a server, referred to herein as a “host server.” The host server is configured to execute an instance of software referred to as a backend.

The backend is configured to correlate (1) demographic data, (2) personal care concern data, and/or (3) medical diagnosis data associated with a user of the system (referred to herein as the “user” or the “customer”) to sets of active and inactive ingredients therapeutic or otherwise beneficial to one or more personal concerns or symptoms that the user likely presents or exhibits.

For simplicity of description the embodiments that follow reference implementations in which a vending machine as described herein is configured to recommend one or more skincare products or, in some examples, one or more skincare ingredients that may be mixed to create customer-specific skincare products. It may be appreciated, however that this is merely one example and that a vending machine as described herein can be configured to recommend and/or mix/select cosmetic products, haircare products, dental care products, nutrition products, and so on.

Further, it may be appreciated, that a recommendation system as described herein can be architected in a number of ways; the foregoing and following examples are not exhaustive of the configurations or purposes of a system such as described herein; other constructions and system architectures are possible. More specifically, it may be appreciated that a system described herein can be trained and/or configured to provide recommendations of non-personal care products, services, or any other suitable durable or non-durable good.

In particular, a recommendation system described herein can be configured to operate as or with a backend system to collect information from a user that may be useful to diagnose one or more skin health or appearance metrics (collectively, “conditions” or “concerns”) exhibited by the user. This data is collectively referred to herein as “customer information”, “user data” and/or a “user dataset.” For example, in many embodiments, the backend system may communicably couple to a client device operated by a user in order to present the user with a questionnaire. The backend system can collect customer information via the client device prior to the user interacting with a vending machine, as described herein or—in some embodiments—the backend system can be configured to collect customer information from the client device while the user/customer is proximate to a vending machine as described herein.

For example, a vending machine as described herein can be configured to display a scannable code, such as a QR code. A client device, such as a cellular phone, can scan the QR code to cause the client device to load a web page hosted by (either directly or indirectly) the backend system. The web page can display a questionnaire as described herein that can be used to collect demographic information/customer information as described herein.

In other cases, scanning a QR code as described above can cause a client device of a customer, a vending machine, and/or a backend system to access a user account associated with the customer. The user account can be stored at the backend system and/or within the vending machine itself. The user account can be used to access customer information, such as described above (e.g., customer information collected prior to the user interacting with the vending machine, or interacting with the vending machine a prior time).

The customer's/user's responses to the questionnaire, along with other demographic and/or geographic data of the user can be consumed by a “predictive model.” As used herein, the phrase “predictive model” refers to any hardware, software, or other circuit or processor or combination thereof configured to execute any suitable pattern recognition or classification algorithm, probabilistic model, artificial intelligence method, untrained or trained learning algorithms (e.g., supervised or unsupervised learning, reinforcement learning, feature learning, sparse dictionary learning, anomaly detection, or association rules, and the like). These learning algorithms may utilize a single or any suitable combination of various models such as artificial neural networks, decision trees, support vector networks, Bayesian networks, genetic algorithms, or training models such as federated learning.

A “diagnostic” predictive model is a predictive model trained and/or otherwise configured to output a metric (or matrix, array, dictionary, list, or set of metrics) corresponding to a statistical likelihood that a given user exhibits a particular skin condition or characteristic. For example, a diagnostic predictive model may be configured to output a matrix, which can be referred to as a diagnostic matrix. The diagnostic matrix can include a number of entries, each associated with a particular skin attribute, condition, or characteristic. In this architecture, the value of each entry of the diagnostic matrix corresponds to a statistical likelihood that the user exhibits a particular associated skin condition or characteristic.

In many embodiments, a diagnostic predictive model is trained by scraping information from customer reviews and other data sources (e.g., scientific journal publications, transcripts of video reviews, blog posts, and so on) available to the general public. More specifically, in many examples, a review author's demographics (e.g., age, sex, ethnicity, and so on) and geographic data (e.g., when the review was authored, where the author lives, and so on) can be extracted from review content and/or a profile page of that author along with a rating (e.g., a star rating) and information or data about the product(s) that are the subject of the review. In addition, skin concern and/or skin diagnosis information can be extracted from a body and/or title or other content of the review.

Likewise, ingredient information, including both active ingredients and inactive ingredients, can be obtained once one or more products that are the subject of the review are identified. In many embodiments, ingredient content by volume can be estimated based on an order in which the ingredients are presented and/or from literature associated with the identified product that may be supplied by a manufacturer of the product (e.g., instructions for use, marketing materials, and so on) or by a third party (e.g., a regulatory body, such as the Food and Drug Administration).

Further, a sentiment analysis operation can be performed to determine a positive sentiment, a neutral sentiment, or a negative sentiment (and/or a magnitude thereof) by the author of the review. Once the foregoing data items, and/or other data which may be obtained from other databases or from the review content, are obtained, such data can be inserted into a training data database table (or other data structure) in order to train the diagnostic predictive mode to determine correlations between positive and/or negative use experiences, user demographics, user skin concerns, and specific ingredients commonly found in retail or prescription personal care products.

After the user data and/or the user geographic data are consumed by the predictive model, the predictive model may output a matrix or other data structure including one or more entries, each of which corresponds to a prediction (e.g., a statistical likelihood) of whether the user presents with a specific skin concern associated with that entry. This matrix is referred to herein as a “diagnostic matrix.”

Thereafter, the diagnostic matrix and/or the user demographic data (along with the geographic data) can be consumed by another predictive model, trained from the same or different data used to train the diagnostic predictive model, to obtain a list of ingredients (and/or therapies, and/or other therapeutic or otherwise beneficial interventions) that are likely to elicit a positive product review from the user or, in another phrasing, likely to address one or more likely skin concerns referenced in the diagnostic matrix. This listing of ingredients, which can include active ingredients and inactive ingredients, can be filtered at least in part in view of information gathered by the system after querying one or more: drug interaction databases; ingredient interaction databases; medical interaction databases; user preference profiles or databases; and so on.

Once a user-specific ingredient listing is obtained (e.g., by a recommendation system of a vending machine as described herein), systems and methods described herein can be configured to select and/or mix a custom personal care product containing at least a threshold number (or percentage, or other quantity) of those ingredients.

The product can be prepared by selecting a base (or bulk) from a set of bases and mixing that base with one or more additives that may be discrete ingredients or combinations of commonly co-present ingredients. Thereafter, the custom personal care product can be dispensed to the customer via a dispensing system of the vending machine.

In certain embodiments, custom personal care products such as those described herein can be modified based on a user's location and/or a vending machine location. For example, moisture content in a custom moisturizer may be different for users ordering custom products for use in (or from) high humidity geographies than for users ordering custom products from (or in) low humidity geographies.

As noted above and with respect to many embodiments described herein, custom personal care products, such as those described herein, can be customized to individual users further by leveraging data related to: local weather; a time of year or season; local water hardness; local or municipal water additives; local ultraviolet index; local pollution metrics; local air quality metrics; and so on. In this manner, as a user moves from place to place or as seasons change, custom personal care products, which may address similar or identical skincare conditions, may be differently customized for a given user.

In some embodiments, custom personal care products such as those described herein can be modified and/or customized based on changing needs of a given user. For example, as a preference or condition of a user is addressed (or changed or improved), that user's personal care product needs may correspondingly change Similarly, as noted above, as seasons change and/or local weather or water hardness changes, a user's personal care product needs may correspondingly change. Embodiments described herein are configured to provide custom products based on time or season of year, user-specific needs, user geographic information, and the like.

In view of the foregoing, it may be appreciated that generally and broadly the embodiments described herein reference, without limitation, (1) methods of generating product and ingredient recommendations for particular customers/users based on responses to a questionnaire and other collected customer information, (2) methods of leveraging that customer information to inform operation of a vending machine, (3) methods of operating a vending machine by a user to receive custom personal care products, and the like.

Broadly, a vending machine as described herein can be configured to couple to a backend service configured to store customer information; the vending machine can generate custom recommendations for customers based on input received from the backend system. For example, a customer having an account with the backend system can simply present a code and/or their personal electronic device to the vending machine which can, in response, automatically generate product/ingredient recommendations and can select appropriate products from a vending machine inventory.

In other cases, a vending machine can be configured to display a questionnaire as described herein to collect customer information in order to automatically generate product/ingredient recommendations and select appropriate products from the vending machine inventory.

In yet other cases, a user can complete a questionnaire on his or her personal electronic device and present a code or other input to a nearby vending machine which may recognize the presence of the customer (e.g., via code sharing, via Bluetooth LE beaconing, or any other suitable proximity-based information) and automatically generate product/ingredient recommendations and select appropriate products from the vending machine inventory.

In yet other examples, a user can maintain an account with a backend service as described herein that is regularly updated by the user or by the backend service to include new information (e.g., weather information, season information, new user preferences, user medical record updates, and so on). A vending machine as described herein can present a user interface that can be leveraged by the user to log into the account to permit the vending machine and/or the backend service to automatically generate product/ingredient recommendations and select appropriate products from a vending machine inventory.

In yet other examples, a vending machine as described herein can be configured to select and/or mix customer-specific personal care products well in advance of the customer approaching the machine. For example, a vending machine as described herein can be configured to create and package and store a suite of products custom to a particular user in anticipation of the user, at a later time, approaching the machine and collecting their products.

In other cases, a vending machine as described herein may be configured to print custom shipping labels such that a shipping carrier can collect prelabeled packaged output from the vending machine and ship said packages to customer/recipients.

As such, generally and broadly, the embodiments described herein all relate to systems for aggregating customer information, using that customer information to generate customer-specific personal care product ingredient recommendations, and dispensing those ingredients to a customer in customer mixtures via, for example, a vending machine. The recommendation system can be contained entirely or partially within a cabinet of the vending machine. In other cases, recommendations can be made by an external server or service, such as a backend service. In other cases, recommendations can be made by an application instance executing on a customer's own device.

A vending machine, a customer device, and a backend system as described herein can communicate in any suitable manner. In some cases, a customer device can communicate with a vending machine via a local communication channel or interface, such as Bluetooth or Wi-Fi. In other cases, a vending machine, a customer device, and a backend system can communicate via a public network, such as one including the open Internet. In other cases, QR codes or other manually or automatically scanned codes (e.g., via NFC, RFID, or other) can communicably couple a vending machine, a customer device, and/or a backend system as described herein.

In view of the foregoing, it may be appreciated that the embodiments described herein generally relate to systems for recommending custom ingredients for skincare products or personal care products to users, systems for manufacturing and/or selecting on demand at a vending machine or similar apparatus custom skincare or personal care products based on those recommendations, and systems and methods for interfacing with customers at a vending machine.

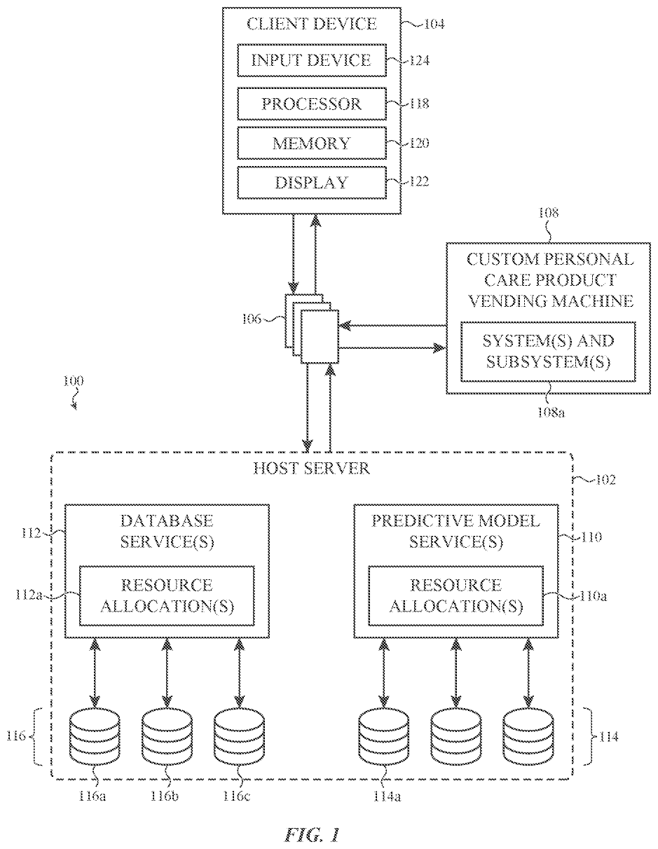

These foregoing and other embodiments are discussed below with reference to FIGS. 1-10. However, those skilled in the art will readily appreciate that the detailed description given herein with respect to these figures is for explanatory purposes only and should not be construed as limiting.

FIG. 1 is a schematic representation of an example recommendation system, such as described herein. In the illustrated embodiment, the system 100 is implemented with a client-server architecture including a host server 102 that communicably couples (e.g., via one or more networking or wired or wireless communication protocols) to one or more client devices, one of which is shown as the client device 104. The client device 104 and the host server 102 of the system 100 can be configured to transact information, identified as the customer information 106, such as, but not limited to: user demographic data; user geographic data; user medical data; and so on.

It may be appreciated that other client devices may be configured in a substantially similar manner as the client device 104, although this may not be required of all embodiments and different client devices can be configured differently and/or may transact data or information with, and/or provide input(s) to, the host server 102 in a unique or device-specific manner. The client device 104 can be any suitable personal or commercial electronic device and may include, without limitation or express requirement, a processor, volatile or non-volatile memory, and a display. Example electronic devices include, but are not limited to: laptop computers; desktop computers; wearable devices; cellular phones; tablet computing devices; and so on. It may be appreciated that a client device 104, such as described herein, can be implemented in any suitable manner.

In many embodiments, the processor of the client device 104 can be configured to execute an application (herein referred to as a “client application”) stored, at least in part, in memory and executed or instantiated directly or indirectly by a processor of the client device 104.

The client application can be configured to access and communicate with the host server 102 and to securely transact information or data with, and provide input(s) to, the host server 102. In some embodiments, the client application may be a browser application configured to access a web page or service hosted by the host server 102 that is accessible to the client device 104 over a private or public network that may, in some embodiments, include the open Internet.

The client device 104 and the host server 102 can each be configured to communicably couple to a vending machine, identified in the illustrated embodiment as the custom personal care product vending machine 108. Specifically, the custom personal care product vending machine 108 can be configured to receive the customer information 106 from either or both the client device 104 or the host server 102.

The custom personal care product vending machine 108 can include multiple discrete systems and subsystems 108a stored and/or enclosed within a cabinet. The cabinet can be subdivided into one or more compartments, some of which may be dedicated to a particular function or system, or some of which may be shared by multiple systems or subsystems of the custom personal care product vending machine 108.

In some embodiments, the custom personal care product vending machine 108 includes a cabinet compartment for storing inventory of the custom personal care product vending machine 108. This compartment may be environmentally controlled. In other words, the compartment may have a controlled temperature, humidity, pressure and/or air quality. In these embodiments, as known to a person of skill in the art, the custom personal care product vending machine 108 can include one or more environmental systems, such as heat exchanger systems, refrigeration systems, humidification systems, dehumidification systems, air purification systems, UV/ion sterilization systems, pressure regulation systems, and so on.

In some cases, the custom personal care product vending machine 108 can include multiple compartments with different environmental controls or requirements. For example a first compartment may be configured to operate as a freezer, whereas another compartment may be configured to operate as a humidity-controlled compartment. A person of skill in the art may readily appreciate that many configurations may be suitable.

In many embodiments, the custom personal care product vending machine 108 includes one or more compartments within its cabinet to retain and enclose control electronics for one or more mechanical or electrical systems of the custom personal care product vending machine 108. For example, as noted above, the custom personal care product vending machine 108 can include a selection system, an operator interface system, a conveying system, a mixing system, a packaging system, a labeling system, a printing system, a dispensing system, a transaction system, and so on. Each of these systems can include and/or may be associated with control electronics physically stored at least partially within a compartment—typically a locked or otherwise inaccessible (or service-accessible) compartment—of the cabinet of the custom personal care product vending machine 108.

Control electronics can vary from embodiment to embodiment, but in many cases, control electronics include a processor allocation and/or a memory allocation configured to intercouple and interoperate to instantiate one or more instances of control software, each of which may be dedicated to controlling one or more physical systems or subsystems of the custom personal care product vending machine 108.

For example, an operator interface system of the custom personal care product vending machine 108 may be associated with an instance of software executing over one or more physical or virtual resources of the custom personal care product vending machine 108. The operator interface system can include a physical display and/or one or more buttons or input affordances that may be operated by a customer of the custom personal care product vending machine 108. In many cases, the instance of software can be configured to render a graphical user interface on the display. The graphical user interface can solicit input and/or interaction from prospective customers in any suitable manner. In some cases, the display/graphical user interface can provide instructions to a user for operating the custom personal care product vending machine 108 to obtain personalized personal care products therefrom.

In many embodiments, the host server 102 is remote to the custom personal care product vending machine 108 and to the client device 104. The host server 102 can be in many embodiments configured to operate within or as a virtual computing environment that is supported by one or more physical servers including one or more hardware resources such as, but not limited to (or requiring) one or more of: a processor; a memory; non-volatile storage; networking connections; and the like. For simplicity of description and illustration, these example hardware resources are not shown in FIG. 1. Such resources may be referred to herein as “resource allocations” of, associated with, and/or supporting the host server 102.

The host server 102 can, like the custom personal care product vending machine 108, instantiate an instance of software to perform, coordinate, or otherwise supervise one or more operations or methods described herein. In particular, in many embodiments, the host server 102 can be configured to instantiate software configured to communicably couple to the client device 104 and to the custom personal care product vending machine 108. For simplicity of description, an instance of software instantiated by the host server 102 is referred to herein as a “backend” software instance. Correspondingly, software executed on the client device 104 and the custom personal care product vending machine 108 may be referred to here as “frontend” software instances, each configured to interface and/or exchange information with the backend software instance supported by the host server 102.

In many embodiments, the host server 102 can include a number of discrete subservices or purpose-configured modules, containers, or virtual machines each configured to perform, coordinate, serve, or otherwise provide one or more services, functions, or operations of the host server 102, such as, but not limited to (1) serving a questionnaire to a user operating the client device 104 or a user operating a frontend interface of the custom personal care product vending machine 108, (2) receiving a response from the client device 104 (or the custom personal care product vending machine 108) containing customer information (e.g., geographic data, questionnaire responses, demographic data, preference data and so on), (3) determining a diagnosis of one or more personal care concerns presented by the user by leveraging a predictive model trained by information obtained from at least customer review data scraped from a public or private resource, (4) determining a user-specific ingredient list by leveraging a predictive model trained by information obtained from at least customer review data scraped from a public resource, and (5) determining or selecting a personal care product base and one or more personal care product additives that can be mixed together to create or select a user-specific personal care product at the custom personal care product vending machine 108. In addition, the host server 102 can be configured to generate training data and to train the one or more predictive models. Many constructions are possible.

To perform these and other operations, the host server 102 of the system 100 can include one or more purpose-configured modules or services. For example, in many embodiments, the host server 102 includes a predictive model service 110 and a database service 112, which may be communicably coupled to each other and/or to one or more other services or functional elements of the host server 102 (not shown).

The predictive model service 110 of the host server 102 can be configured to host and/or otherwise service requests to access one or more predictive models that may be trained in a particular manner and/or may serve a particular function.

For example, as described herein, the predictive model service 110 can be configured to provide access to a diagnostic predictive model configured to ingest a user dataset (customer information in a structured format) and to output a diagnostic matrix, entries of which correspond to a probabilistic assessment of a likelihood that the particular user presents with a given or particular personal care concern.

In other cases, the predictive model service 110 may be configured to provide access to a consumer review predictive model configured to ingest a diagnostic matrix, a user dataset and/or other information, and to output a customer review prediction matrix, entries of which correspond to a probabilistic assessment of likelihood that a particular ingredient, if used by the user in a recommended manner, would elicit a positive product review from that user.

In some embodiments, the predictive model service 110 can be configured to provide access to other predictive models, trained in any suitable manner against any suitable data. In many cases, a predictive model served by the predictive model service 110 of the host server 102 can be stored in any suitable form or format in a database accessible to the predictive model service 110, such as the databases 114, one of which is identified as the model database 114a. The predictive model service 110 and the various functions and operations thereof is described in greater detail with reference to embodiments that follow.

The database service 112 of the host server 102 can be configured to host and/or otherwise service requests to access to one or more databases or data sources, internal or external to the host server 102. Example databases, access which is facilitated and/or controlled by the database server 108, are illustrated as the databases 116 and can include, without limitation: an ingredient interaction database 116a; a drug interaction database 116b; an ingredient database 116c; a product database; a customer review database; a scientific journal or study information database; and so on.

In many cases, the database service 112 of the host server 102 can be configured to access one or more remote or third party databases to obtain information. An example of a third party database that may be accessed by a database service, such as described herein, includes: a water hardness database; a weather prediction database; a customer database; a customer review database; a scientific journal or study database; and the like.

Each of the predictive model service 110 and the database service 112 are associated with allocations of physical or virtual resources (identified in the figure as the resource allocations 110a and 112a respectively), such as one or more processors, memory, and/or communication modules (e.g., network connections and the like), that such an implementation is not required.

More generally, it may be appreciated that the various functions described herein of a host server 102 can be performed by any suitable physical hardware, virtual machine, containerized machine, or any combination thereof. Similarly, it may be appreciated that the client device 104 can be implemented in a number of suitable ways. In one embodiment, the client device 104 includes a processor 118, a memory 120, a display 122, and an input sensor or input device 124. These components can cooperate to perform or coordinate one or more operations of the client device 104 as it communicates with and transacts information with the host server 102 and/or the custom personal care product vending machine 108.

The system 100 can be leveraged by a user to obtain user-specific personal care products. In one example, skincare products.

For example, a user/prospective customer may approach the custom personal care product vending machine 108. The user can operate a user interface of the custom personal care product vending machine 108 to complete a questionnaire collecting demographic information, skin concern information, dermatological information, personal care product preference information, and/or medical information. This information can be provided as input by the custom personal care product vending machine 108 to the host server 102 which can leverage a predictive model of the predictive model service 110 to generate a list of ingredients suitable for the user's preferences and concerns. This list can be communicated from the host server 102 to the custom personal care product vending machine 108 which, in turn, can leverage a transaction system to collect payment information from the user. Once a transaction is complete, the custom personal care product vending machine 108 can leverage a selection system and/or a mixing system and/or a conveying system to select an appropriate pre-mixed or mixed-on-demand product containing at least a threshold number of the set of ingredients from an inventory compartment of the custom personal care product vending machine 108 to dispense to the user. More simply, in this embodiment, a user can leverage a display of the custom personal care product vending machine 108 to provide enough customer information sufficient to generate a custom skincare product and/or routine recommendation.

In another example, a user/prospective customer of customer skincare services may leverage the client device 104 to load a web page hosted by the host server 102. In this example, the user can operate a user interface of the client device 104 to complete a questionnaire collecting demographic information, skin concern information, dermatological information, personal care product preference information, and/or medical information. This information can be provided as input by the client device 104 to the host server 102 which can leverage a predictive model of the predictive model service 110 to generate a list of ingredients suitable for the user's preferences and concerns. This list can be communicated from the host server 102 to the custom personal care product vending machine 108 or, in the alternative, to the client device 104. Thereafter, the user may approach the custom personal care product vending machine 108 and may enter a user-specific code or scan a vending-machine specific code from the custom personal care product vending machine 108. In response to scanning this code, the custom personal care product vending machine 108 can identify the user of the client device 104 as the user who previously filled out the questionnaire. Once the user/customer is identified (e.g., customer information is obtained/accessed from memory and/or requested from the client device 104 or the host server 102), the custom personal care product vending machine 108 and/or the client device 104, can leverage a transaction system to collect payment information from the user. Once a transaction is complete (by the custom personal care product vending machine 108 or the client device 104), the custom personal care product vending machine 108 can, as within other embodiments, leverage a selection system and/or a mixing system and/or a conveying system to select an appropriate pre-mixed or mixed-on-demand product containing at least a threshold number of the set of ingredients from an inventory compartment of the custom personal care product vending machine 108 to dispense to the user. More simply, in this embodiment, a user can leverage a display of the client device 104 to provide enough customer information sufficient to generate a custom skincare product and/or routine recommendation, prior to interacting with the custom personal care product vending machine 108.

In another embodiment, the host server 102 can include an account service that stores customer information associated with particular customers. In these examples, a user can operate a user interface of the custom personal care product vending machine 108 to access that user's account information at the host server 102 to, without limitation: re-order previously ordered custom skincare products; modify answers to a questionnaire previously completed; complete a previously started but not finished questionnaire; modify a previously ordered skincare product; order a different size of a previously-ordered skincare product; and so on.

In another embodiment, the custom personal care product vending machine 108 and/or the host server 102 can be configured to modify a set of ingredients and/or relative proportions of those ingredients based on information not provided directly by a user. For example, as noted above, the custom personal care product vending machine 108 may be positioned in a travel center such as an airport. In these examples, the custom personal care product vending machine 108 can be configured to obtain traveler information such as travel duration and travel destination(s). In these examples, the custom personal care product vending machine 108 and the host server 102 can modify skincare recommendations and/or products and product sizes dispensed from the custom personal care product vending machine 108 based on the traveler information.

For example, a user may approach the custom personal care product vending machine 108, which may be installed at an airport. The user may enter itinerary information into a user interface of the custom personal care product vending machine 108 or, in some cases, the custom personal care product vending machine 108 may be configured to scan a boarding pass of the user to obtain itinerary information. In other examples, the client device 104 may be configured to communicably intercouple with the custom personal care product vending machine 108 to provide itinerary information to the custom personal care product vending machine 108.

In one example, the user may be travelling to a Caribbean island for seven days, thereafter traveling to western Europe for fourteen days, thereafter travelling to a Scandinavian country for three days, before returning home to the American southwest. The user may leverage the interface of the custom personal care product vending machine 108 to complete a questionnaire soliciting information from the user. The system 100 may determine, upon completion of the questionnaire that the user is primarily concerned with facial acne. Based on the user's demographics, the system 100 may recommend to the user a custom skincare product containing a retinoid.

However, as known to a person of skill in the art, retinoid products typically increases a patient's skin's sun sensitivity. In this example, the system 100 may recommend a seven-day regimen of a salicylic acid cream, along with a seven-day supply of a high SPF, low moisturizer, sunscreen. These two custom products may be used by the user/traveler during the portion of the traveler's trip in the Caribbean, during which it is reasonable to anticipate high UV exposure and high humidity exposure. The system may thereafter recommend a fourteen day regimen of a retinoid cream, along with a fourteen day supply of a medium-SPF sunscreen with moisturizer. These two custom products may be used by the user/traveler during the portion of the traveler's trip in western Europe, during which weather is predicted to be cold and overcast. Finally, the system may recommend a different concentration of retinoid and a different sunscreen as the traveler visits Scandinavia. The system 100 may further recommend that the user order, for delivery in 25 days' time, anti-acne and SPF suitable for the user in the American southwest so that the user can continue the skincare regimen uninterrupted upon returning home.

In many embodiments, each of these different recommendations may be based at least in part on the traveler's information—including the duration of travel and the location of travel and the anticipated environmental conditions that may be experienced by the traveler when the traveler arrives at those locations.

In yet other examples, a user's input to the system 100 can be leveraged to create different skincare products at different physical vending machines. For example, the user of the preceding example may be able to leverage vending machines at each destination airport to obtain products specific to that location; as the user arrives in the Caribbean, a vending machine installed there can have already made for the user skincare products to be used by the user when the user is in the Caribbean. In some cases the vending machine may also have a recycling option for a user to return and/or re-use previously filled containers.

The foregoing embodiment depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

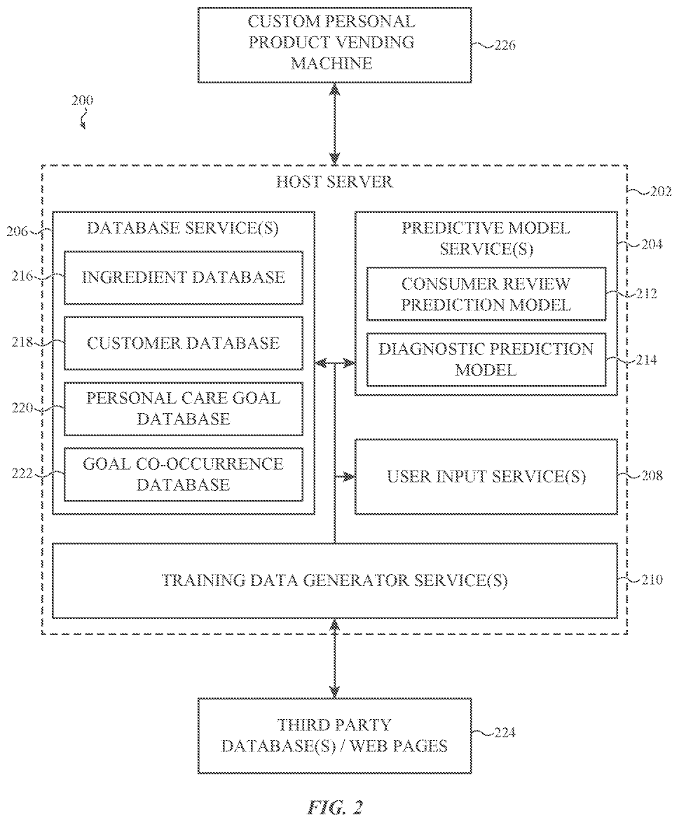

FIG. 2 is a schematic representation of a host server of the client-server architecture of the system of FIG. 1. In this embodiment, the system 200 includes a host server 202 which, in turn, is defined by a number of discrete and purpose-configured components. In particular, the host server 202 can include a predictive model service 204, a database service 206, a user input service 208, and a training data generator service 210.

As noted with respect to other embodiments described herein, the predictive model service 204 of the host server 202 can facilitate access to, and data transactions with, one or more predictive models, such as a consumer review prediction model 212 and a diagnostic prediction model 214.

As noted with respect to other embodiments described herein, the consumer review prediction model 212 can be configured to perform an operation to assess a statistical likelihood that a particular ingredient, if used by a particular user (associated with particular customer information), is likely to elicit a positive review from that user with respect to a personal care concern of that user.

As noted above, the consumer review prediction model 212 can be trained with data extracted from one or more public and/or private databases comprising consumer reviews of personal care products. In particular, the consumer review prediction model 212 can be trained to determine correlations between demographic and geographic data associated with an author of a review, the ingredient set of a product that is the subject of that review, and one or more skin concerns or conditions mentioned in that review.

Once trained on a sufficiently large dataset, the consumer review prediction model 212 can predict whether a given user exhibiting a skin concern (or other personal care attribute, condition, or problem) is likely to successfully treat the condition associated with a specific ingredient. The various functions and operations of a consumer review prediction model, such as the consumer review prediction model 212 depicted in FIG. 2, are described in greater detail below.

Similarly, the diagnostic prediction model 214 can be configured, in some embodiments, to perform an operation to assess a statistical likelihood that a particular user dataset consumed by the model corresponds to a user that presents with a specific given skin concern.

More generally, the diagnostic prediction model 214 can be configured to output a diagnostic matrix, each entry of which corresponds to a statistical assessment or prediction of a likelihood that a skin concern associated with that particular entry is presented by a given user. As noted above, the diagnostic prediction model 214 can also be trained with data extracted from one or more public and/or private databases comprising consumer reviews of personal care products (and/or scientific journal or study data).

In particular, the diagnostic prediction model 214 can be trained to determine correlations between demographic and geographic data associated with an author of a review and one or more skin concerns or conditions mentioned in that review. Similar to the consumer review prediction model 212, once trained on a sufficiently large dataset, the diagnostic prediction model 214 can predict whether a given user exhibits or is likely to present with one or more skin concerns.

As noted with respect to other embodiments described herein, the database service 206 of the host server 202 can facilitate access to, and data transactions with, one or more databases such as, but not limited to: an active and/or inactive ingredient database 216; a customer database 218; a personal care interest/goal database 220; and/or a personal care goal/interest co-occurrence database 222.

In one embodiment, the active and/or inactive ingredient database 216 is configured to store information related to ingredients that may be used in one or more personal care products, whether customized or otherwise.

Information contained in the active and/or inactive ingredient database 216 can include, but may not be limited to: an ingredient name; an ingredient identifier; an ingredient status identifier (e.g., active or inactive); an ingredient source; an environmental impact metric of an ingredient; a price per unit of the ingredient; allergy information associated with the ingredient; interaction information associated with the ingredient; an ingredient description; a list or identifier of a skin concern for which the ingredient is therapeutic or otherwise beneficial; and so on and the like.

The customer database 218 can be configured in any suitable manner to store user data and/or demographic data or geographic data. As with other embodiments described herein, the customer database 218 can contain information related to any suitable personal care product or goal, but for simplicity of illustration and description, skincare products and concerns are referenced below. Example information that may be included in a customer database 218 include, but are not limited to: a user name; a user age; a self-reported user skin type; a user skin concern (or set of skin concerns or unique identifier corresponding to a set of skin concerns); an ethnicity or set of ethnicities; a geographic location of the user; and so on.

In many cases, the customer database 218 can store historical information as well, noting and recording changes in a user's skincare recommendations and/or changes in demographic or geographic data over time.

The personal care interest/goal database 220 can be configured in any suitable manner to store information related to skin concerns that can be diagnosed by the system 200 or, more particularly, the diagnostic prediction model 214 of the predictive model service 204 of the host server 202. In many embodiments, the personal care interest/goal database 220 is configured to store, without limitation: a skin concern identifier; a skin concern symptom list; a set of one or more diagnostics that, if exhibited by a user, increase a statistical likelihood that the user exhibits the skin concern; and so on.

The personal care goal/interest co-occurrence database 222 can be configured in any suitable manner to store information related to statistical likelihoods of a particular personal care goals or concerns occurring with another personal care concerns based on population data and/or demographic data of users exhibiting said conditions. For example, dry skin may also be associated with dry hair or nails, reporting of any of which can inform personal care product formulations for each concern. More particularly, if a user reports that the user experiences dry skin, the system may recommend adjusting a formulation of the user's conditioner, despite that the user did not provide direct input indicating dry hair was also a concern.

In the illustrated configuration, the personal care goal/interest co-occurrence database 222 can be leveraged by the host server 202 to determine which diagnosis among a set of diagnoses output by the diagnostic prediction model 214 are more likely to be correct diagnoses than others.

The training data generator service 210 of the host server 202 can be configured to iteratively or otherwise obtain training data to update training of one or more of the models of the predictive model service 204. In particular, in many embodiments, the training data generator service 210 is configured to scrape information from publicly-accessible consumer review and/or scientific dermatological study/survey databases (collectively identified as the third party databases 224) and to extract data from those databases to generate training data that correlates particular demographic characteristics (of the authors of customer reviews and/or of the subject(s) of scientific studies) and one or more therapeutic or otherwise beneficial active or inactive ingredients of the product(s) that are the subject of those reviews/studies.

All of these cooperating systems and models can be used to inform product mixing instructions and/or product selection instructions sent by the host server 202 to one or more custom personal product vending machines, such as the custom personal product vending machine 226.

It may be appreciated that the foregoing description of FIG. 2, and the various alternatives thereof and variations thereto, are presented, generally, for purposes of explanation, and to facilitate a thorough understanding of various possible configurations of a recommendation system, such as described herein.

However, it will be apparent to one skilled in the art that some of the specific details presented herein may not be required in order to practice a particular described embodiment, or an equivalent thereof. For example, it may be appreciated that the host server 202 depicted in FIG. 2 can be configured to transact information with the client device 104 to provide recommendations to a user operating the client device 104 in a number of suitable ways.

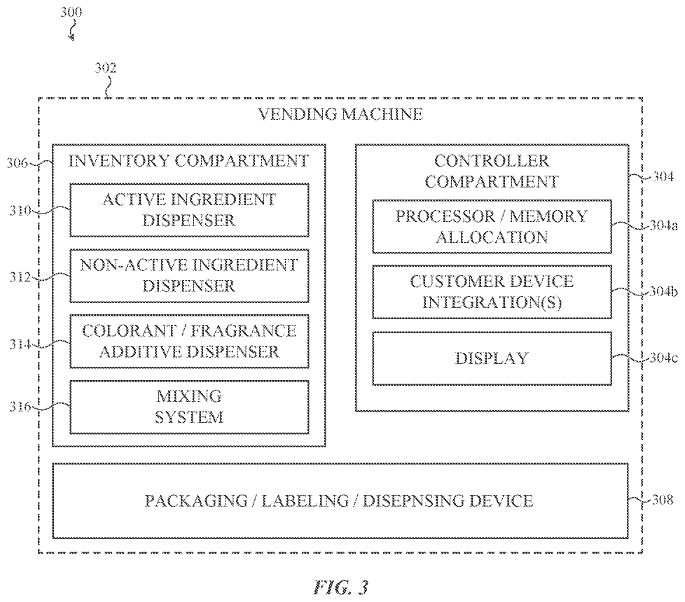

For example, a vending machine as described herein that is configured to participate in a recommendation system as described herein can be configured in a number of suitable ways. In one example, shown in FIG. 3, a vending machine 300 can include a cabinet 302 that encloses and supports multiple compartments, such as a controller compartment 304 and an inventory compartment 306. In addition, the vending machine 300 can include a packaging, labelling, and dispensing device 308 which may provide a compartment for a user of the vending machine 300 to retrieve a purchased product.

The controller compartment 304 can retain and support any suitable electronic and/or mechanical hardware associated with control, operation, powering, or other functionality of the vending machine 300. For example, the controller compartment 304 can contain and enclose a processor and/or memory allocation 304a, a network interface element 304b configured to communicably couple to, and/or integrate with, a customer device (such as a cellular phone or laptop), and a display 304c.

In these embodiments, the display 304c can be used to receive input from a user and/or provide instructions to the vending machine 300. The display 304c can be operated by an instance of software instantiated over the processor and/or memory allocation 304a. The instance of software may be configured, in some embodiments, to communicably couple to a personal electronic device of a user, such as a cellular phone. In these examples, the software instance can operate the network interface element 304b (e.g., which may leverage Wi-Fi or Bluetooth or another suitable communication technology) to exchange information with the personal electronic device.

The inventory control compartment 306 can contain a number of discrete subsystems such as, but not limited to, an active ingredient dispensing system 310, a non-active ingredient dispensing system 312, a colorant/fragrance dispensing system 314, and a mixing system 316. The mixing system 316 can be configured to select a container, and fill that container with appropriate proportions of appropriate active ingredients, non-active ingredients, and other ingredients such as colors and fragrances by cooperating with the other systems of the vending machine 300. In this manner, the vending machine 300 can be operated to generate a custom personal care product formulation on demand.

In other cases, mixing of products may not be required. In these examples, common and/or typical product formulations may be stored in the vending machine and may be provided to a user as a closest match to the user's custom ingredient list. In other cases, different pre-mixed custom skincare products can be provided to a user for mixing by the user after purchase. In some cases, a custom skincare product can be provided to the user to mix with or to use with a retail product available to, or already owned by, the user.

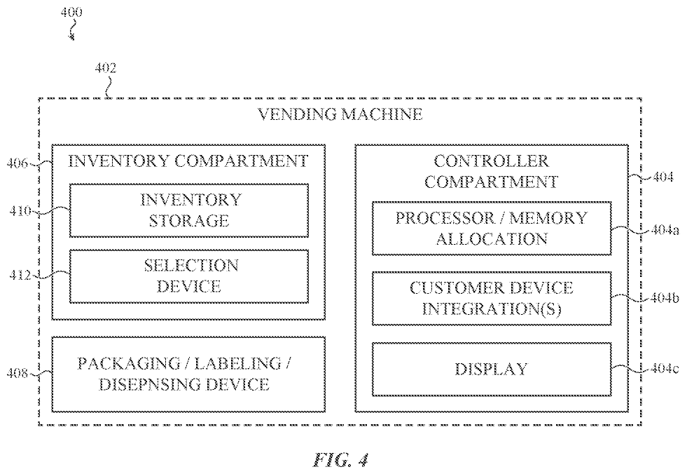

In these embodiments in FIG. 4, as with other embodiments described herein, the display 404c can be used to receive input from a user and/or provide instructions to the vending machine 400. The display 404c can be operated by an instance of software instantiated over the processor and/or memory allocation 404a.

The instance of software may be configured, in some embodiments, to communicably couple to a personal electronic device of a user, such as a cellular phone. In these examples, the software instance can operate the network interface element 404b (e.g., which may leverage Wi-Fi or Bluetooth or another suitable communication technology) to exchange information with the personal electronic device.

The inventory control compartment 406 can contain a number of discrete subsystems such as, but not limited to, an inventory storage system 410 and an inventory selection system 412. The inventory storage system 410 can be an environmentally controlled storage system that operates with the inventory selection system 412 to provide selected product formulations stored in the inventory storage system 410 to the packaging, labelling, and dispensing device 408 which in turn can print one or more custom labels and/or custom literature (e.g., customer names, destination/intended use environment names, regimen information, and so on).

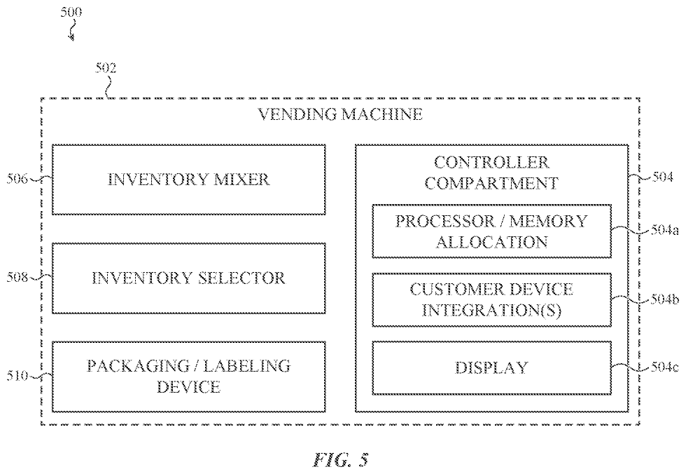

In yet other embodiments, a vending machine as described herein can be configured to provide both custom mixing functionality and custom pre-mixed selection functionality. FIG. 5 depicts a vending machine 500 can include a cabinet 502 that encloses and supports multiple compartments, including a controller compartment 504.

As with other embodiments described herein, the controller compartment 504 can retain and support any suitable electronic and/or mechanical hardware associated with control, operation, powering, or other functionality of the vending machine 500. For example, the controller compartment 504 can contain and enclose a processor and/or memory allocation 504a, a network interface element 504b configured to communicably couple to, and/or integrate with, a customer device (such as a cellular phone or laptop), and a display 504c each of which may be configured as described in reference to other embodiments provided herein.

The vending machine 500 can include an inventory mixing system 506, which may operate such as described in reference to FIG. 3, and an inventory selection system 508, which may operate as described in reference to FIG. 4. In addition, as with other embodiments described herein, the vending machine 500 can include a packaging, labeling, and dispensing system 510.

It may be appreciated that the foregoing description of FIGS. 3-5, and the various alternatives thereof and variations thereto, are presented, generally, for purposes of explanation, and to facilitate a thorough understanding of various possible configurations of a vending machine, such as described herein.

However, it will be apparent to one skilled in the art that some of the specific details presented herein may not be required in order to practice a particular described embodiment, or an equivalent thereof.

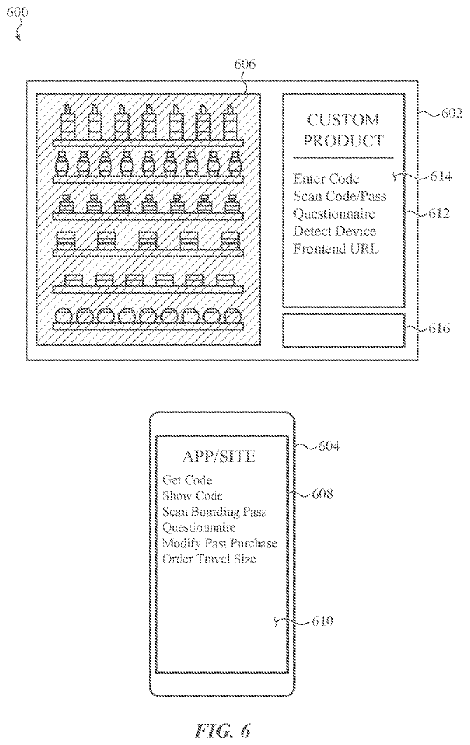

FIG. 6 depicts a vending machine, as described herein. The vending machine 600 includes a cabinet 602 that encloses control electronics and operational systems such as described herein. The vending machine 600 may be configured to communicably couple to a client device 604 operated by a customer of the vending machine 600. The customer may be able to view one or more customer personal care products offered by the vending machine through an inventory viewing window 606 (which may not be included in all embodiments).

In some examples, the client device 604 can be used by the user to interact with, provide instructions to, and/or otherwise cooperate with the vending machine 600. For example, a display 608 of the client device 604 can render a graphical user interface 610 that may be used by the user to interact with the vending machine 600. In other cases, the user may interact with a display 612 of the vending machine 600 that itself renders a graphical user interface 614.

Once the user provides information to the vending machine 600 via the graphical user interface 610 and/or the graphical user interface 614, a custom product or product mixture can be provided to the user via the product dispensing door 616.

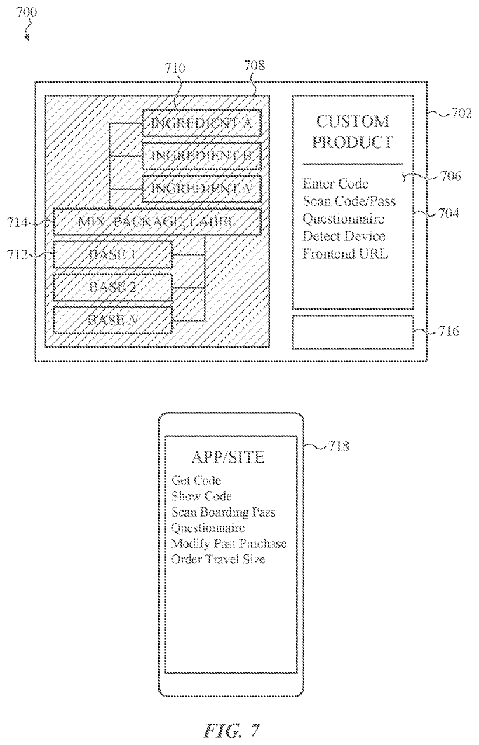

In another embodiment shown in FIG. 7, a vending machine 700 can include a cabinet 702 that encloses a display 704 that renders a graphical user interface 706 which can be used to complete a questionnaire, enter a code to access previously-entered customer information or purchase preferences, to detect presence of a particular customer device, and so on. As with other embodiments described herein, the vending machine 700 can be used by a customer to purchase customer-specific personal care products, which may be mixed within the machine itself. For example, the vending machine 700 can include a viewing window 708 through which a user may observe a process of selecting one or more active ingredients 710 and/or one or more inactive ingredients (or bases) 712 by a mixing, packaging, and labelling system 714 which, in turn, may provide a customized product to a customer via a product dispensing door 716.

As with many embodiments described herein, the vending machine 700 can be configured to interface with a user's personal cellular phone (such as the personal electronic device 718) or other personal electronic device and/or a backend system as described above to collect customer information and to provide custom product recommendations based on that information.

It may be appreciated that the foregoing description of FIGS. 6-7, and the various alternatives thereof and variations thereto, are presented, generally, for purposes of explanation, and to facilitate a thorough understanding of various possible configurations of a vending machine, such as described herein.

However, it will be apparent to one skilled in the art that some of the specific details presented herein may not be required in order to practice a particular described embodiment, or an equivalent thereof.

For example, in some cases, a user may identify to a vending machine by entering a code. The vending machine can submit that code to a backend system to associate the code with a user account and/or with particular customer information. In some cases, the code may be transmitted to the vending machine by a cellular phone, in other cases the code may be manually entered by a user. In some cases, the code may be scanned by the cellular phone or a code displayed by the cellular phone may be scanned by the vending machine. In some cases, the vending machine can include one or more biometric sensors that can be leveraged to determine a user's identity (e.g., fingerprints, iris scanning, and so on). In other cases, a vending machine can be configured to monitor for a beacon, such as a Bluetooth low energy beacon, emitted by an electronic device under the control of a customer. These embodiments are not exhaustive; it may be appreciated that generally and broadly the embodiments described herein operate by identifying a user to a vending machine, obtaining information about that user, generating custom personal care products from that information, and so on. The manner by which a user is identified by a system described herein, or by which user information is collected, may vary from embodiment to embodiment.

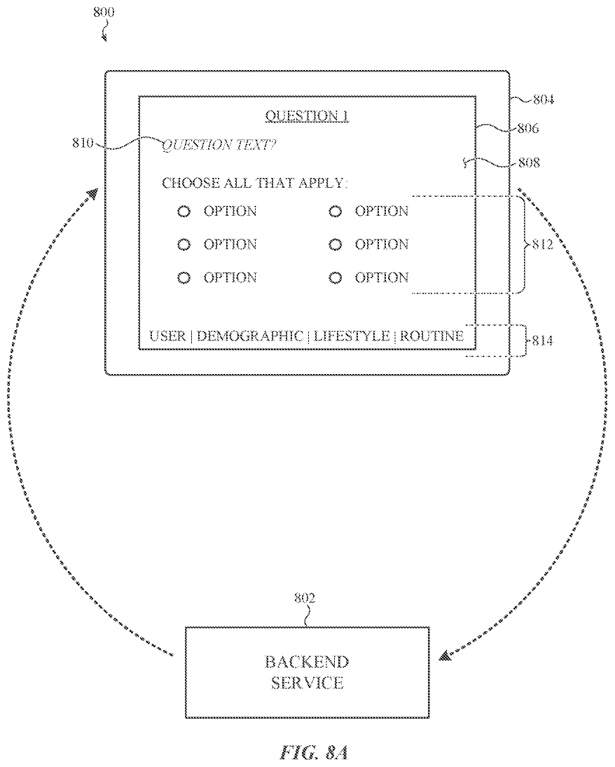

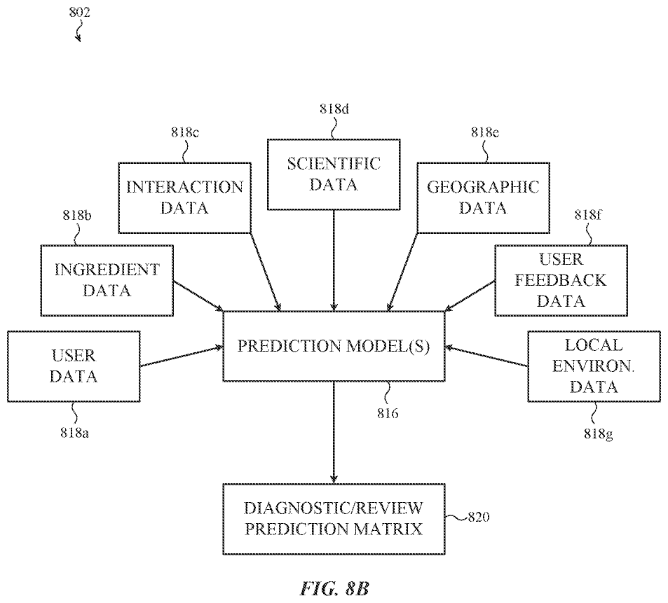

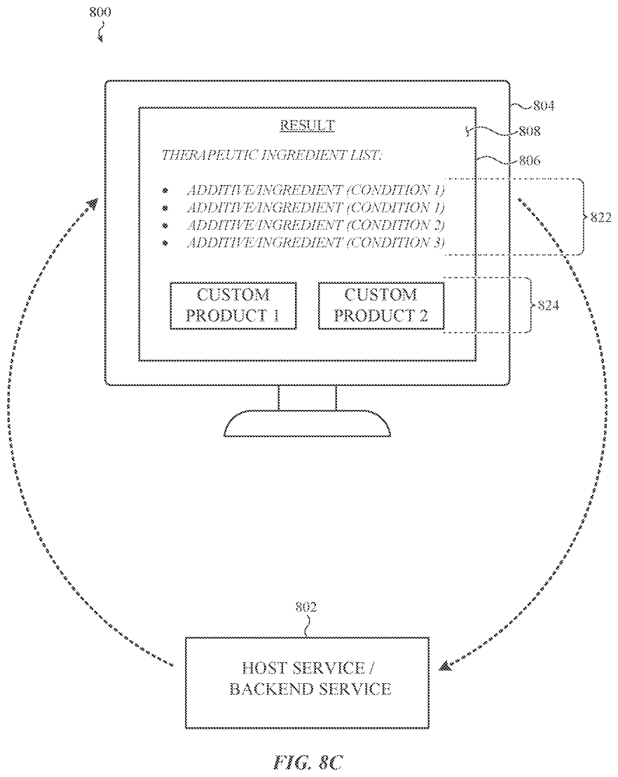

For example, FIG. 8A is a signal/process flow diagram depicting a client device in communication with the host server of FIG. 2 and rendering a graphical user interface configured to solicit input from a user of the client device so that the host server can provide a recommendation to that user or to a vending machine accessible to the user to formulate and dispense a custom product to that user. In particular, in this embodiment, the recommendation system 800 includes a backend service instance 802 in communication with a frontend instance 804. The frontend instance 804 may be operated or instantiated on a vending machine as described herein or, in some examples, on a client device as described herein.

The frontend instance 804 operates a display 806 that renders a graphical user interface 808. In this example, the graphical user interface 808 renders a portion of a questionnaire that can be served to the frontend instance 804 to solicit user information from a user operating the frontend instance 804. In this embodiment, the graphical user interface 808 can present a question 810 to the user.

In response to the question 810, the user may select one or more options, such as the options 812 to provide demographic information to the backend service instance 802 such that the backend service instance 802 can provide a recommendation for a personal care product to the user.

The question(s) asked of the user by the backend service instance 802 can thematically vary (see, e.g., the questionnaire sections 814). For example, as depicted in FIG. 8A, questions can be asked of the user related to the user's personal care concerns, user demographics, user lifestyle (e.g., activity level, outdoor activity, swimming activity, and so on), user personal care regimens, and so on.

More specifically, the host server 802 can be configured to consume data from a variety of sources in order to generate one or more recommendations for the user. FIG. 8B is a signal/process flow diagram depicting data source(s) accessible to the host server of FIG. 8A that can supply information or data to a predictive model to ingest to provide a recommendation to the user.

In this example, the backend service instance 802 includes a prediction model 816 that can receive data from a variety of sources, in any suitable form and format, such as a user data datasource 818a, an ingredient data datasource 818b, an ingredient interaction data datasource 818c, a scientific data datasource 818d, a geographic data datasource 818e, a user feedback data datasource 818f, a local environment data datasource 818g, and so on. Once the prediction model 816 consumes data retrieved from one or more of these datasources (or other data sources), the prediction model 816 can output a prediction matrix 820, which may be a diagnostic prediction matrix or a customer review prediction matrix.

In response to generation of one or more prediction matrices, the recommendation system 802 can be configured to provide one or more recommendations to the user. FIG. 8C is a signal/process flow diagram depicting the client device of FIG. 8A rendering a graphical user interface presenting one or more product recommendations to the user of the client device. In this embodiment, the host server 802 instructs the frontend instance 804 to display, via the display 806 and the graphical user interface 808, a set of recommendations 822 for the user. In some embodiments, the user may be further presented with an option to purchase a customized product by selecting a custom product 824.

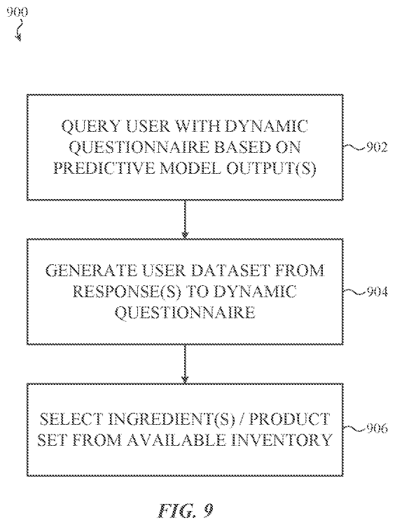

FIG. 9 is a flowchart corresponding to a method of operating a system as described herein which can include a vending machine. The method 900 can be performed, in whole or in part, by any suitable service, server, processor, or other computational resource allocation associated with a host server, vending machine, or client device, such as described herein.

For example, the method 900 can be performed in whole or in part by a host server such as described above in reference to FIGS. 1-2. In one example, the method 900 can be performed by a server or cluster of communicably coupled servers that are configured to communicate with a client device of a user, such as a cellular phone or a laptop or desktop computer.

The method 900 includes operation 902 (which may be optional in some embodiments), in which a host server serves or otherwise provides a diagnostic survey or questionnaire to the user via a frontend graphical user interface displayed on a client device or a display of a vending machine. As noted with respect to other embodiments described herein, the diagnostic survey or questionnaire can include any number of suitable questions, taking any suitable form or format, and may be dynamic or static.

For example, in some embodiments, a static questionnaire can be served in a machine-readable format by the host server to the client device. Once the machine-readable format is received by the client device, a processor of the client device can cause a client application executed by that processor to render one or more questions on a display of the client device or vending machine.

The questions of the questionnaire can be presented by the client device or vending machine in any suitable manner, including but not limited to: presenting one question at a time; presenting related questions together; presenting questions divided into groups; and so on. The questions of the static questionnaire can be any suitable questions that solicit input from the user operating the client device or vending machine. In these and related embodiments, all users accessing the host server can be served the same questionnaire.

In other embodiments, a static questionnaire served to a client device or vending machine to solicit input from a particular user by the host server can be selected from a set or group of static questionnaires stored in a database accessible to the host server.

In these examples, the host server and/or client device or vending machine can select a single static questionnaire based on one or more characteristics of the user. For example, in some embodiments, the static questionnaire served to a particular user may be based on that user's demographic data (e.g., age, sex, location, preferred language, and so on).

In one particular example, a first static questionnaire can be served to male users whereas a second static questionnaire can be served to female users. It may be appreciated, however that this is merely one example; a person of skill in the art will readily appreciate that any suitable number of static questionnaires can be stored by a database service (or other, third-party or first-party storage medium, apparatus, or appliance) of a host server, such as described herein. Examples include static questionnaires selected based on: gender of a user; geographic location of a user; age of a user; age group of a user; medical condition of a user; allergy of a user; lifestyle of a user (e.g., active, sedentary, and so on); and the like.

In still further embodiments, the method 900 at operation 902 serves or otherwise provides a dynamic diagnostic survey or questionnaire to the user via a client device or vending machine. In these examples, a dynamic questionnaire may ask questions in an order and with content specific to the user answering those questions. A client device or vending machine providing a dynamic questionnaire served by the host server can be configured to present follow-up questions, to omit irrelevant questions (as determined by user input, user demographics, and/or answers to previously-presented questions), to ask supplemental questions, and so on.

These examples are not exhaustive; a person of skill in the art will readily appreciate that a host server and/or a client device can be configured in any suitable manner to ask questions of a user in a dynamic manner.

For example, in some embodiments, the host server can be configured to transmit the dynamic questionnaire in a machine-readable format to a client device or vending machine. The client device or vending machine can parse the machine-readable format of the dynamic questionnaire in order to determine which questions to ask, in which order, and at what time. In these cases, the machine-readable format can encode information related to a variety of paths that may be taken by a user through a series or set of questions of the dynamic questionnaire. These paths may change, may fork in different directions, or may terminate based on user input to questions presented to the user.

In other examples, the host server can be configured to transmit questions, individually or in groups, to the client device or vending machine and the client device or vending machine can be configured to transmit answers to those questions back to the host server. Upon receiving user input in response to transmitting one or more questions to the client device or vending machine, the host server can determine which questions to ask of the user next. In some embodiments, the host server can leverage a predictive model, such as described above, in order to determine an order in which to ask specific questions of a specific user (e.g., a user exhibiting or presenting with particular skin concerns, particular demographics and the like).

For example, the predictive model can be trained with user interaction data (e.g., dwell time, click-through rate, and the like) to determine which questions of a given set of questions are more likely to be answered by users than others.

In these examples, the predictive model may be configured to determine a statistical likelihood of whether a particular user is likely to answer a given question truthfully, quickly, thoughtfully (e.g., by providing detailed input), or whether that particular user is likely to skip the given question or to exit the dynamic questionnaire altogether. In these embodiments, the predictive model can be leveraged to determine which questions are asked in which order of which user.

For example, the predictive model may determine that a first age bracket (e.g., 30 to 40) is more likely to provide input and/or answer questions of a questionnaire with more than 20 questions, whereas a second age bracket (e.g., 16 to 24) is less likely to provide input and/or answers questions to a questionnaire of that length. In this example, the predictive model may present a shorter dynamic questionnaire to younger users in order to improve click-through and/or completion of the questionnaire for users in that age bracket.

In another example, the predictive model may determine that users indicating a concern with comedones may exhibit an increased click-through or completion rate for longer questionnaires whereas users indicating a concern with dry skin may exhibit a decreased click-through rate or completion rate for longer questionnaires.

In this example, the predictive model may present a shorter dynamic questionnaire to users concerned with dry skin and may present a longer dynamic questionnaire to users concerned with comedones in order to improve click-through and/or completion of the questionnaire for users with both concerns.

Regardless the form or format of the questionnaire, whether static or dynamic, it may be appreciated that questions associated with a questionnaire described herein can be presented in any suitable form or format. Example questions, as noted above, can include without limitation: questions answerable by selecting one option among a list of options; questions answerable by providing written, typed, spoken, or otherwise recorded user input; optional questions; required questions; questions answerable by selecting one or more options among a list of options; and so on and the like.

The questions of a questionnaire that can be served by a host server to a client device or vending machine, such as described herein, can include questions soliciting input from the user related to skin concerns such as questions asking whether the user is concerned with: dry, oily, or flaky skin in a particular area; wrinkled skin (e.g., fine lines, deep wrinkles); a skin irritation; loss of firmness or elasticity of skin; skin puffiness; discoloration (e.g., hyperpigmentation, hypopigmentation, vitiligo, melasma, dark spots, sun spots, liver spots, age spots, redness); a perceived skin dullness; blemishes, comedones (closed or open), or scarring; a frequency of a recurring skin concern (e.g., frequency of breakouts, seasonal dryness, and so on); hormonal effects on skin of pregnancy, hormone replacement or supplement therapy, menopause/perimenopause, postpartum; new or worsening skin sensitivity; skin damage (e.g., abrasion, scarring, burning, and the like); a visible appearance of pores; skin texture; visibility of veins; sunken skin or dropping skin; and so on and the like. Other personal care issues can be associated with different concerns, attributes, and properties. Example other personal care products or concerns include: haircare; hygiene; nailcare; nutrition; digestive care; dental care; eyecare; and so on.

The questions of a questionnaire can further include demographic questions such as but not limited to: name; address; ethnicity(ies); age; sex; gender; and so on. In still other examples, the questions of a questionnaire can include medical information such as, but not limited to: allergy information; medication information; dietary information; activity level/lifestyle information; and so on. It may be appreciated that these examples are not exhaustive; a questionnaire such as described herein can solicit any suitable information from a user; the quantity, detail, depth, and type of information or data solicited from a user may vary from embodiment to embodiment.

Once a questionnaire has been completed by the user operating a client device or vending machine, the method 900 can advance to operation 904 at which a customer dataset, also referred to as customer information, can be generated. Thereafter, at operation 906, the dataset can be leveraged by a predictive model as described herein to select a set of ingredients, both active and inactive, and/or products, from an inventory available in one or more retail locations and/or vending machines.

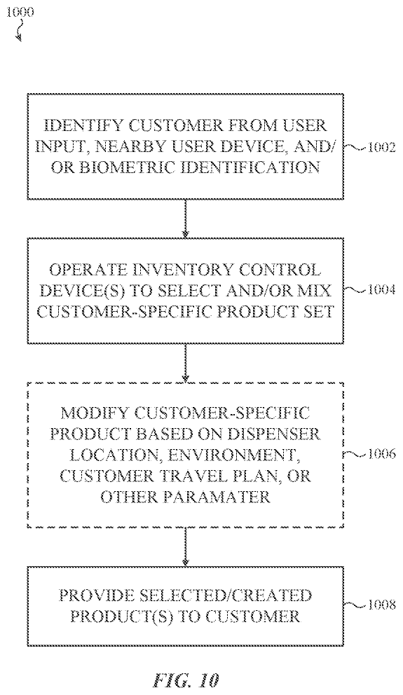

FIG. 10 is a flowchart depicting example operations of a method 1000 of operating a vending machine as described herein. The method 1000 includes operation 1002 at which a particular user is identified to the vending machine. The identification can be made by biometric identification means, by monitoring for presence of a nearby electronic device associated with the user, or in any other suitable manner. Once the user is identified, a custom ingredient set may be obtained leveraging systems and methods described herein. Thereafter at operation 1004, one or more inventory control systems of the vending machine can be operated to select one or more ingredients to create a custom formulation for the identified user. Next, optionally at operation 1006, the ingredient list may be modified based on one or more user-specific attributes or properties, an anticipated upcoming change to the customer information (e.g., seasonal change, travel plans), or any other suitable trigger. Finally, at operation 1008, the selected ingredients—optionally modified—may be combined and the custom product may be provided to the user via a dispensing system of the vending machine.

It is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, although many embodiments described herein leverage output(s) of one or more predictive models that consume user geographic and/or demographic data to inform production of a customized or custom-tailored personal care product (e.g., by combining a skincare base and one or more skincare additives), this is not required of all embodiments. For example, it may be appreciated that any suitable embodiment described herein can be modified to leverage output of a predictive model to select and recommend to a user one or more personal care products from a set of personal care products.

In these examples, a host server and/or a predictive model of the host server can be configured to select the one or more personal care products based on a quantity of active and/or inactive/cosmetic ingredients contained in those products that match with active and inactive ingredients output from the predictive model. In other cases, one or more personal care products can be selected from a set of personal care products based on one or more active ingredients of the selected personal care products that are determined by the predictive model to be of greater therapeutic and/or otherwise beneficial use to the user. These examples are not exhaustive; it is appreciated that any suitable embodiment described herein, along with equivalents thereof, can be suitably modified to, without limitation: recommend existing products; generate custom products; recommend routine changes; recommend a user stop using a specified product or ingredient; recommend the user consult a dermatologist or aesthetician; recommend the user adopt a particular skincare routine; recommend the user adjust the user's diet; recommend the user purchase a water filter for the user's primary residence; recommend the user wear or avoid wearing particular clothing or jewelry; recommend the user change detergents; soaps, or other products used by the user; and so on or any combination thereof.

For example, as noted above, although the embodiments presented herein reference methods of leveraging predictive models trained by scraping customer review data, scientific data, and other data sources to generate a diagnosis of a skin concern and, additionally, product and, more specifically, product attribute (e.g., ingredients) recommendations to a user exhibiting those skin concerns, it may be appreciated that this is merely one implementation and configuration and use of a system described herein.

In other cases, a system such as described herein can be trained and/or otherwise configured to, without limitation: provide durable goods recommendations and/or custom manufacturing; provide medical diagnoses outside of the skincare field; provide cosmetic recommendations; provide allergy and/or medical condition diagnoses; provide dietary recommendations; provide lifestyle change recommendations; and so on.

Accordingly, one may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data including health data or health-related data such as described herein will preferably comply with published and industry-established privacy, data, and network security policies and practices. For example, it is understood that data and/or information obtained from remote or local data sources, only on informed consent of the subject of that data and/or information, should be accessed and aggregated only for legitimate, agreed-upon, and reasonable uses.

We claim:

1. A system as described herein.

2. A vending machine as described herein.

3. A method of operating a vending machine as described herein.
